(19) United States
(12) Patent Application Publication
(10) Pub. No.: US 2003/0217125 A1
(43) Pub. Date: Nov. 20, 2003

(54) Intelligent end user gateway device

(75) Inventors: Thomas S. Brancati, Hamden, CT (US); Steven F. Knittel, West Allenhurst, NJ (US); Madhav Moganti, Piscataway, NJ (US)

Correspondence Address: MOSER, PATTERSON & SHERIDAN L.L.P., 595 SHREWSBURY AVE, FIRST FLOOR, SHREWSBURY, NJ, 07702, US

(73) Assignee: LUCENT TECHNOLOGIES, INC.

(21) Appl. No.: 10/146,398

(22) Filed: May 15, 2002

(51) Int. Cl. G06F 15/177

(52) U.S. Cl. 709/220; 709/224; 709/313

(57) ABSTRACT

A method of providing network intelligence between an intelligent end-user gateway (IEUG) device and a plurality of intelligent network layers. The method includes generating an end-user diary including goals, goal-related plans, and tasks to fulfill the plans. The end-user diary is sent to at least one of the plurality of intelligent network layers, where the at least one of the plurality of intelligent network layers update a user profile from the end-user diary and send goal related information to the IEUG device. The IEUG performs the tasks and plans to fulfill the goals based on the goal related information.

### CROSS-REFERENCES

The present patent application is related to commonly assigned and concurrently filed patent application Ser. No. ______, filed ______ (Attorney Docket: Knittel 4-4), entitled “SELF-ORGANIZING INTELLIGENT NETWORK ARCHITECTURE AND METHODOLOGY”, which is hereby incorporated by reference in its entirety.

### FIELD OF INVENTION

The present invention relates to communication networks. More specifically, the present invention relates to intelligent network architecture and specifically to end user intelligent device architecture.

### DESCRIPTION OF THE BACKGROUND ART

Current communication industry practice generally assumes that networking consists of largely predictable processes that can safely proceed without the benefit of, or need for, in-process measurement and real-time feedback. Most adjustments in networking processes are made by service provider operators that often use intuition and experience to tune parameters. As the technological changes are occurring at a faster pace, there is not enough consideration given to the need for real-time planning or replanning, automatic service adaptability, real-time resource optimization, or adaptability to changing conditions. Real-time schedule changes, provisioning, configuration, and process modifications are handled mostly by manual ad-hoc methods.

Service providers are looking for flexible end-to-end networks to benefit from reduced operations costs, which translate into more competitive, cost-effective service offerings. Unfortunately, a manageable communication network intelligence that ties all these separate areas of knowledge into a unified framework has been lacking. Communication industry developers are developing end user intelligence gathering techniques, such as Cookie-based knowledge. In this situation, web applications running on the end user Workstations/PC's keep track of the web interactions being performed by the end user. This information is then used the next time the user again visits the same web sites in which case the “Cookies” help the end-user navigate web sites more effectively.

While current generic end-user gateway concepts are primarily aimed at filling needs for the consumer, the generic end-user gateway concepts also meets the requirements of network operators. The main concern for the latter group is in having a standardized interface point for network operations and design, given the dramatic impacts of telecommunications deregulation on the consumer. Expanded bandwidth capability is rapidly being distributed further into lower levels of the communication service, such that network activity at the end-user node has taken on increased importance. The advancing technology brings more complexity and cost to residential communications, and consumers increasingly become the prime focus of future networks and standardized interfaces. As a result, CPE (Customer Premise Equipment) deployed at the end-user level is in need of additional functionality and coordination in order to provide intelligent communication between service-provider and end-user nodes. Furthermore, the benefits of standardized devices would lessen cost burdens and complexity for consumers.

As such, there has been a lack of manageable communication network intelligence between the end-user devices and the network, itself.

### SUMMARY OF THE INVENTION

The disadvantages heretofore associated with the prior art, are overcome by the present invention a method and apparatus for providing network intelligence between an intelligent end-user gateway (IEUG) device and a plurality of intelligent network layers. The method includes generating an end-user diary including goals, goal-related plans, and tasks to fulfill the plans. The end-user diary is sent to at least one of the plurality of intelligent network layers, where the at least one of the plurality of intelligent network layers update a user profile from the end-user diary and send goal related information to the IEUG device. The IEUG performs the tasks and plans to fulfill the goals based on the goal related information.

The intelligent end-user gateway (IEUG) device provides end-user device intelligence to an intelligent network. In particular, the IEUG device comprises a plurality of functional layers for providing respective functions within a hierarchy of functions, where each of the functional layers include a respective agent for vertically propagating information between hierarchically adjacent layers. Each of the functional layers includes at least one element for implementing at least one respective layer function, wherein each functional layer agent, in response to a respective task-indicative subset of the vertically propagated information, horizontally propagates to respective functional layer elements at least that information necessary to perform an indicated task. Furthermore, each functional layer agent vertically propagates information pertaining to the indicated task.

### BRIEF DESCRIPTION OF THE DRAWINGS

The teachings of the present invention can be readily understood by considering the following detailed description in conjunction with the accompanying drawings, in which:

FIG. 1 depicts a flow diagram of functional end-to-end traffic flow for a hierarchal interconnected and layered intelligent network;

FIG. 2 depicts a high-level block diagram of a customer premise hardware environment having an intelligent end-user gateway (IEUG) device;

FIG. 3 depicts a flow diagram of various elements of network intelligence and their functional relationships;

FIG. 4 depicts a flow diagram of dynamically interconnected layered network nodes representing the self-organizing network of FIG. 1;

FIG. 5 depicts a high-level block diagram of an intelligent end-user network management module of the IEUG of FIG. 2;

FIG. 6 depicts a detailed block diagram of the IEUG device hardware architecture;

FIG. 7 depicts a block diagram of the IEUG device software architecture; and

FIG. 8 depicts a flow chart representing intelligence update control flow between the IEUG and network management.

To facilitate understanding, identical reference numerals have been used, where possible, to designate identical elements that are common to the figures.

### DETAILED DESCRIPTION OF THE INVENTION

Intelligent communication networks require the ability to understand the communications environment, to make decisions, and to efficiently utilize and manage the network resources. Sophisticated levels of intelligence include the ability to recognize various user, application, service provider, and infrastructure needs, as well as expected and unexpected events. The collection of information and the ability to respond in logical actions represents knowledge in a communication world model, which further enables an intelligent communication network to reason and plan for the future.

For purposes herein, communication network intelligence is defined as the ability of a network system to act appropriately in an (uncertain) environment, where appropriate action is such action that promotes optimal and efficient use of network resources in delivering high-quality services, and success is the achievement of behavioral sub-goals that support, for example, a service provider's overall goals. Both the criteria of success and the service provider's overall goals are defined external to the intelligent system. The goals and success criteria are typically defined by the business objectives of the service provider and implemented by network designers, programmers, and operators. Network intelligence is the integration of knowledge and feedback into an input-output-based interactive goal-directed networked system that can plan and generate effective, purposeful action directed toward achieving them.

Various degrees or levels of network intelligence are determined by the computational power of the network and network elements, the sophistication of algorithms the system uses for input and output processing, world modeling, behavior generation, value assessment, communication, and the information and data values the network system can access. Accordingly, network intelligence evolves through growth in computational power and through the accumulation of knowledge on the types of input data required, decisions regarding output responses, and processing needed in a complex and changing environment. Increasing sophistication of network intelligence produces capabilities for look-ahead planning and management before responding, and reasoning about the probable results of alternative actions. These abilities of intelligent networks can provide competitive and operational advantage to the service providers over the traditional networks.

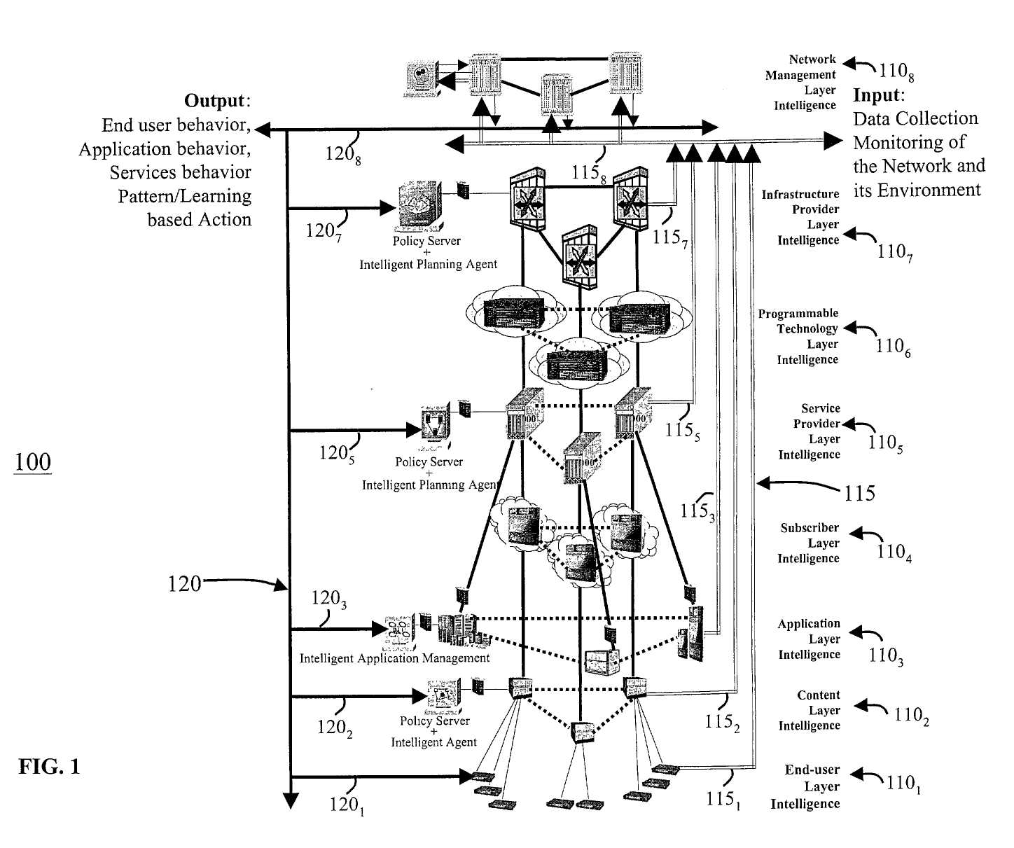

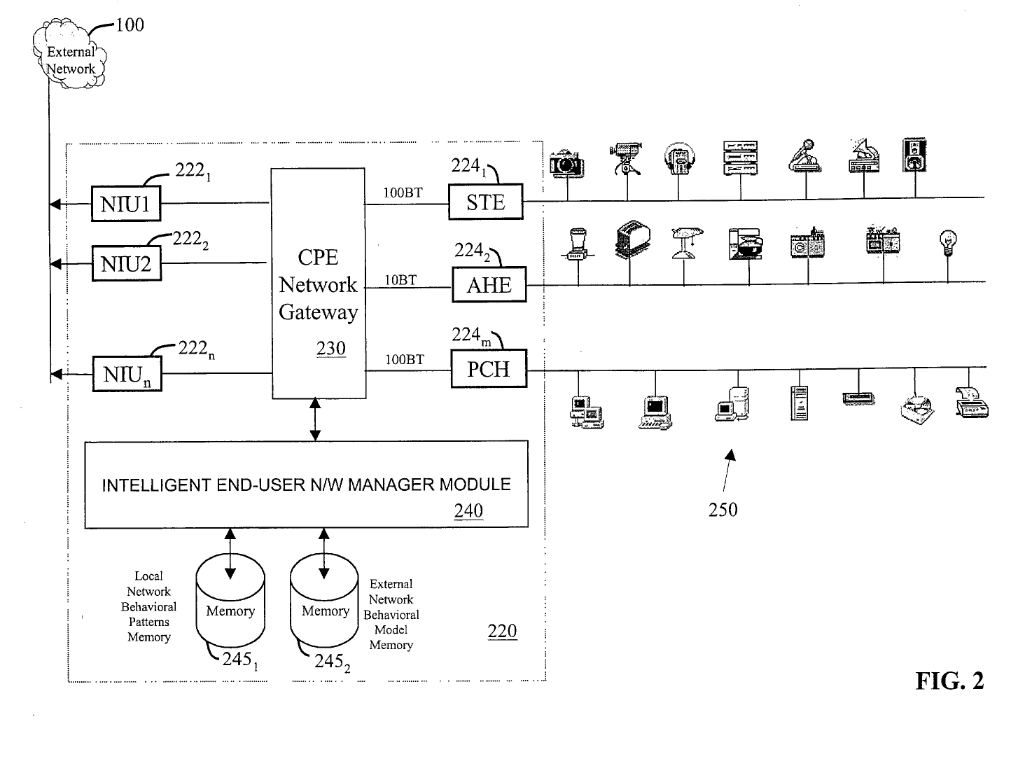

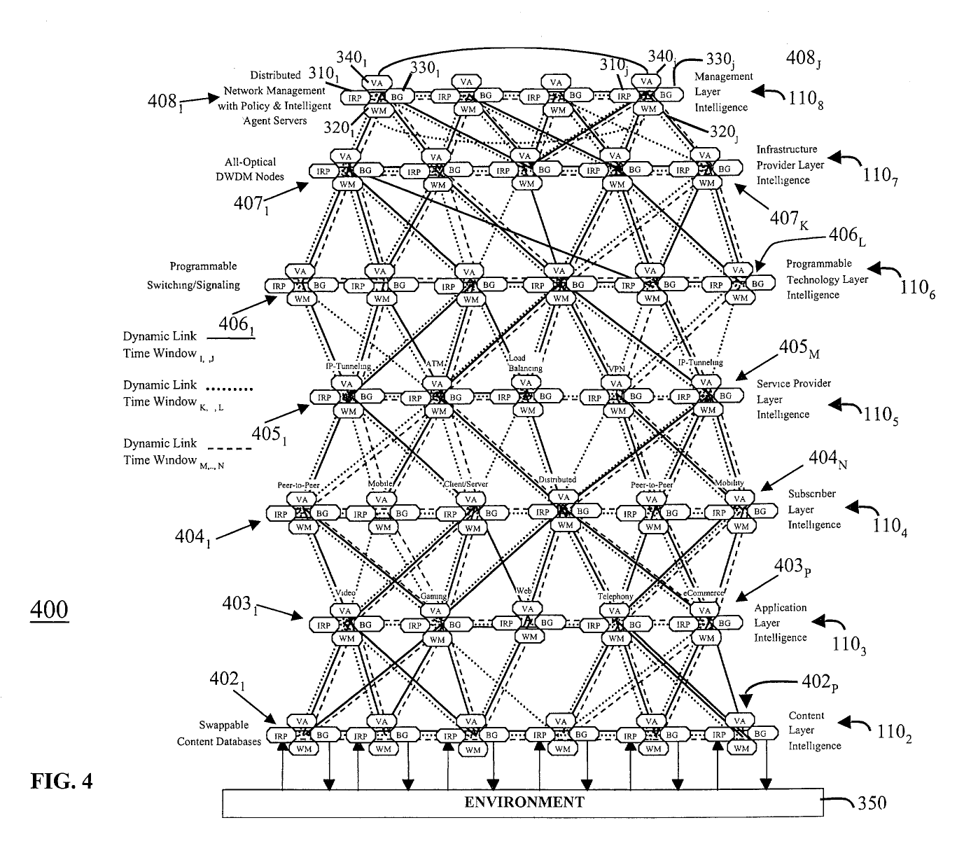

The present invention is an intelligent end-user gateway (IEUG) device that is able to monitor, generate, and communicate end-user behavioral patterns to other network components. In turn, other network elements can also communicate their temporal traffic load and characteristics to the IEUG end-user device to allow for intelligent decisions in providing high-quality services to the end user. In one embodiment, the IEUG is implemented and considered a part of the end-user or customer's hardware environment, as opposed to being a part of the service provider's hardware environment. For a better understanding of the IEUG device, the invention is initially discussed with regard to FIGS. 1 and 4, in the context of an intelligent network system. A more detailed discussion of the IEUG device, itself, is discussed further with regard to FIGS. 2, 3, and 5-8.

FIG. 1 depicts a flow diagram of functional traffic flow in an end-to-end interconnected and layered intelligent network system 100. The illustrative intelligent network comprises a plurality of hierarchal levels 110 including an end-user layer 110₁, a content layer 110₂, an application layer 110₃, a subscriber layer 110₄, a service provider layer 110₅, a programmable technology layer 110₆, an infrastructure provider layer 110₇, and a network manager layer 110₈. A plurality of horizontal traffic flows is provided between the nodes of each layer 110. For example, phantom lines are shown between the exemplary three nodes of the service provider layer 110₅. Similarly, vertical traffic flow is provided between at least adjacent layers. For example, vertical traffic flow is provided between each of the nodes of the network management layer 110₈ and the nodes of the infrastructure provider layer 110₇. In either instance, the traffic flow, in this context, refers to the utilization of intelligent content. These layered flows are used as a foundation on which the framework of network intelligence is developed. Several intelligent network architectures are discussed herein, such as IP centric Optical networks, intelligent service management and delivery, and intelligent IP tunneling with regard to-end-to-end network intelligence flow issues.

The end-user intelligence layer 110₁ provides the capabilities needed at the user's premises, which are not normally considered part of the service providers' networks. In accordance with the present invention, the IEUG device (e.g., 220 of FIG. 2) is considered a part of the end-user intelligence layer 110₁. The importance of the end-user intelligence layer 110₁ is continuing to grow, based on improvements in access bandwidth available to the end-user. Greater bandwidth availability allows for expanded intelligence within the equipment deployed on the customer premises and requires additional functionality and coordination within the service provider space. One advantage is that content may be provided to the user premises in anticipation of user needs, as well as at times of lower utilization on the service provider's network. Additionally, intelligence at the user's layer 110₁ is important in supporting new services that are tailored to the usage patterns and interests of the users.

The content-based intelligent network 110₂ allocates network bandwidth based on the content and user requirements, as well as safeguards content based on defined access policies. The content-based intelligent network 110₂ comprises various services including content location services, content distribution and replication, content caching, as well as content redirection and forwarding.

The emergence of the Internet has radically changed the way individuals and corporations utilize networks and how information is located and accessed. Currently, if a large number of users want to access a “hot” content area at the same time, “flash” network overloads can occur which stress the infrastructure beyond its limits. The service provider networks are changing the information delivery mechanism from passive content retrieval to proactive content delivery based on network policies and user identity. The passive retrieval model requires a network infrastructure that is built for predictable network and server loads. The proactive delivery model requires that content be intelligently distributed closer to clients and network access points to better cope with sporadic network loads driven by hot content. In the content-based intelligent paradigm, an end user's customer premise equipment (CPE) or device deals with content in the network directly. A content-aware CPE device requires a content-based intelligent network environment and advantageously facilitates the distribution of content requests to locations where the content is requested. This minimizes unnecessary network loads that result from focused overloads or backbone constraints.

The application layer intelligence 110₃ advantageously allows application service providers to more effectively manage application resources to their maximum utilization and return on investment. In particular, the number of applications offered to the end-users that must be supported continues to grow. The traffic carried to support the applications generates different traffic load and flow patterns, which are dependent on various characteristics of the applications. These characteristics of applications include real-time and non real-time, computation intensive and non-intensive, network topology dependent and independent, end user dependent and independent, high bandwidth and low bandwidth, and delay sensitive and insensitive characteristics.

In order to properly design, evaluate, and deploy efficient network gear for an application environment, a service provider requires better understanding of the source models of the network application traffic. In particular, one would like to find invariant characteristics of how an application host generates network traffic. Based on application architectures, design, and human factors, there are a number of reasons why application traffic may vary significantly, such as, user access type, application communication methods, single transaction vs. multiple linked transaction applications, and end user input and interaction strategy.

The subscriber-based intelligent network environment 110₄ consists of a group of customer premise equipment (CPE) or devices communicating and sharing one or more resources in a decentralized way. The subscriber-based intelligent network environment 110₄ is depicted by clouds in FIG. 1, which represent virtual entities or soft devices. This type of networking demands certain relationships between the service providers network elements and the CPE devices. Some of these applications demand particular logical network topologies to enable the applications. Peer-to-peer network applications, cluster-computing, networked parallel processing, and mapping of logical storage area networks on physical/virtual network topologies are some examples of subscriber-based intelligence.

The advantage of the subscriber-based intelligence is to speed-up algorithm execution, minimize inter-node communication delays, improve resource utilization, and provide fault-tolerance by restoring the network connectivity on the occurrence of faults. Features and services can be highly personalized to pre-designated user groups or to an individual using them. In this environment, a user has the choice to select preferred network resource characteristics to activate personalized features and provide information to the system that will improve its performance.

The service provider layer intelligence 110₅ provides the options to carry the end users' traffic by applying service provider constraints to end users needs. Examples of service provider intelligence 110₅ include intelligent tunneling, virtual network switching or routing (using VPNs), and VLANS. The service provider layer illustratively provides various features, such as, quality of service (QoS), isolation, and policing capabilities that allow service providers to deliver flexible, measurable, and enforceable Service Level Agreements (SLA) to other-service providers as well as to subscribers, while allowing the delivery of real-time and non real-time services from multiple sources. These features enable a service provider to provide other large service providers with dedicated virtual resources, as well as allow small service providers to share virtual resources that are administratively managed by the service provider.

The programmable technology layer intelligence 110₆ provides interoperability and adaptability across heterogeneous networks that support a wide range of signaling protocols. The programmable technology layer intelligence 110₆ is depicted with clouds in FIG. 1, which represent virtual entities or soft devices. Programmable switches (e.g., like SOFTSWITCH™) translate industry-signaling protocols into a generic call-signaling format, thereby simplifying the addition of new protocols. This capability allows legacy service providers and new service providers to provide rich, seamless interoperability between their network domains, and enables signaling interworking between multiple vendor gateways. The programmable technology layer intelligence 110₆ enable applications to better react to changing conditions, thereby enabling applications to pro-actively optimize physical layer performance using some application-defined set of metrics.

The infrastructure provider layer intelligence 110₇ allows service providers to build networks capable of supporting a variety of old and new infrastructures, as well as providing new value added services and reduction in costs. The unique problems inherent in simultaneously supporting an existing network, while deploying a new multi-service infrastructure point to a solution that leverages the unique benefits of FR, ATM, IP, and dense wave division multiplexing (DWDM) technologies. The infrastructure layer intelligence 110₇ provides the capabilities to deal with these complexities, such as technologies like DWDM and multi-service platforms. The infrastructure layer intelligence 110₇ may operate in multi-vendor environments, multi-technological environments, and multi-protocol environments.

The network management layer intelligence 110₈ deploys, integrates, and coordinates all the resources necessary to configure, monitor, test, analyze, evaluate, and control the communication network to meet service-level objectives. The driving forces for network management are efficient use of resources, control of strategic assets, minimization of down time, management of constantly changing communications technology and services, and reduction of the cost of the network operations. The network management layer must intelligently integrate diverse services, networks, technologies, and multi-vendor equipment. It is noted that although the network management layer intelligence 110₈ is depicted as a separate layer, in some network management functions the network management layer intelligence 110₈ is distributed across the other layers embedded in element management systems. However, for simplicity and convenience, such embedding is not shown.

In an end-to-end communications network 100, the phenomena of overall network intelligence requires more than a set of disconnected elements. Overall intelligence in networks requires an interconnecting and functionally tightly coupled system architecture that enables the various functional levels to interact and communicate with each other in several ways. That is, the network intelligence considers and responds to the dependence of one layer on the other layer, as well as the effect of change in one layer and the impact and proliferation to the other layers. Furthermore, the network intelligence considers and responds to interrelationships between these several layers, the effect of changes in the network environment in view of each of the layers and the overall network, and the impact of the addition of new technologies, new applications, and new services.

FIG. 1 further depicts a plurality of feedback loops. Self-organizing capabilities of the intelligent network system 100 is obtained by using IRP feedback loops illustratively formed by input loops 115 and output loops 120. For example, input feed back loops 115₁, 115₂, 115₃, 115₅, and 115₇ are depicted as providing information from their respective hierarchal layers 110₁, 110₂, 110₃, 110₅, and 110₇ to the network management layer 110₈. Similarly, the network management layer 110₈ provides information back to the hierarchal layers 110₁, 110₂, 110₃, 110₅, and 110₇ via output feedback loops 120₁, 120₂, 120₃, 120₅, and 120₇.

The feedback loops 115 and 120 are provided to establish self-organizing intelligence, where the intelligent networks 100 may dynamically reconfigure network topologies, and provision resources and services dynamically. As such, the end-to-end intelligent network system 100 monitors, learns about its environment and its impact on the network resources, makes intelligent decisions and takes appropriate actions based on the network behavior observed in the past on an application or time or project driven basis.

FIG. 2 depicts a high-level block diagram of a customer premise hardware environment 250 having an intelligent end-user gateway (IEUG) device 220. In particular, an IEUG device 220 couples a network 100 to various customer premise equipment (CPE) and devices 250. The network 100 is a hierarchal layered network having intelligence elements provided at various nodes of the network 100, as shown in FIG. 1. For a detailed understanding of such intelligent hierarchal layered network, the reader is directed to co-filed patent application entitled “Self-Organizing Intelligent Network Architecture and Methodology”, Ser. No. ______, filed ______, Attorney Docket No. Knittel 4-4, by common assignee Lucent Technologies, Inc. of Murray Hill, N.J.

The customer premise equipment and devices 250 includes various computing devices, such as desktop PC's, servers, workstations, and the like. The CPE 250 may also include various multi-media devices, such as digital cameras, stereo systems, recording devises, set-top boxes, and the like. Alternately, appliances having digital capabilities may also be included as various types of customer premise equipment 250.

The IEUG 220 comprises a CPE gateway 230, one or more network interface units 222, one or more CPE hubs 224, an intelligent end-user network management module 240, and memory 245. The CPE gateway 230 couples one or more network interface units (NIU) 222ₙ to the various customer premise equipment 250 via the one or more CPE hubs 224ₘ. The one or more CPE hubs 224 are utilized to accommodate for varying bandwidth and bit rate requirements for the various types of CPE 110. For example, a set-top hub (STE) 224₁ may be utilized to connect multimedia CPE and devices 250 via a 100BT Ethernet connection. An application hub 224₂ may be used to couple the CPE network gateway 230 to various appliances via a 10BT Ethernet connection. Furthermore, a PC hub 224₃ may be used to couple the CPE network gateway 230 to various computer devices, also via a 100BT Ethernet connection.

The intelligent end-user network management module 240 is provided with memory to store, for example, local network behavioral patterns in memory (e.g., Flash memory) 245₁, as well as external network behavioral patterns in memory (e.g., Flash memory) 245₂. The intelligent end-user network management module 240 communicates with the CPE network gateway 230 as discussed in further detail below.

The main function of the IEUG device 220 is to, process and gather nodal intelligence at the end-user layer 110₁. As will be discussed in further detail below, the IEUG device 220 has intelligence in specialized functional areas allowing it to communicate interactively with various end-user communication devices 250 as well as with the service provider network elements. To this extent, the IEUG 220 is able to learn or anticipate end-user needs and events based on historical observation and current activity and act autonomously in executing a dynamic repertoire of tasks aimed at achieving the desired goal. One could describe the IEUG as a local “network assistant” not only having sets of tools at its disposal, but also capable of organizing their use within the domain of logic and time. In addition to anticipating end-user needs, the IEUG 220 is able to proactively synthesize various end-user service-demands in which functionally related processes and device activities are integrated into an overall unified response/request. This type of end-user intelligent capability provides network optimization for local end-user nodes, as well as the area-wide network itself, along with the justifiable reasons for IEUG decisions and actions.

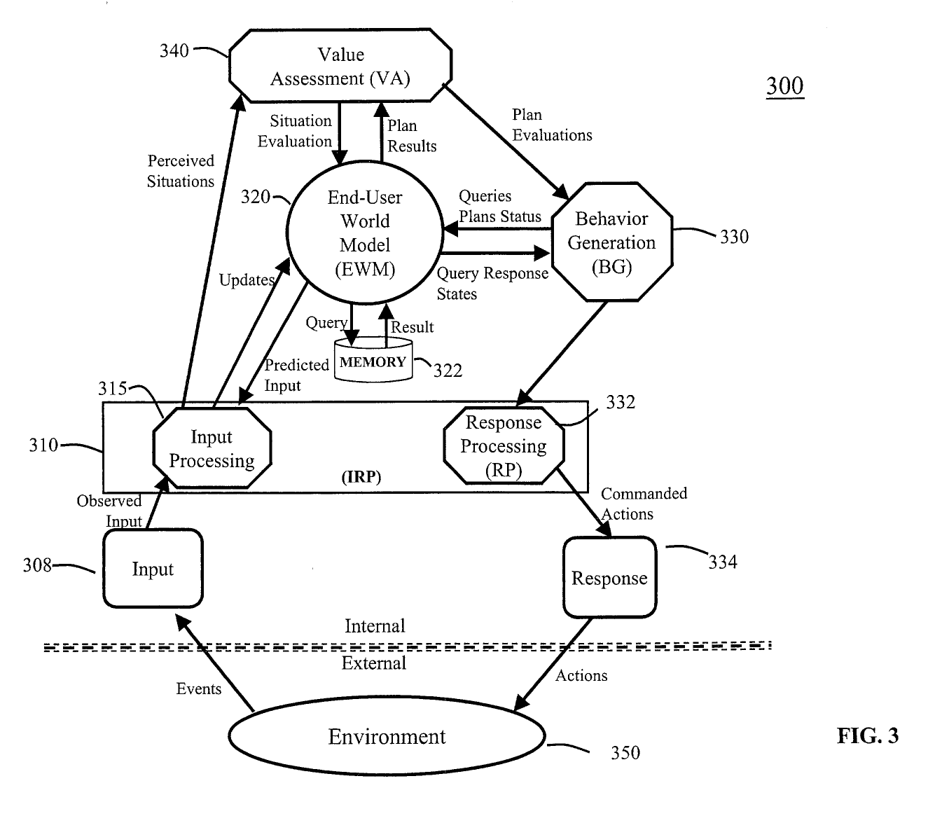

FIG. 3 depicts a flow diagram of various network intelligence modules 300 and their functional relationships. The modules 300 manifest themselves as four (4) discreet functional entities within the IEUG 220 and interact in a logical and coherent fashion in defining the end-user device interfaces to the local network environment 100. The modules 300 of the IEUG 220 comprise an Input/Response Processing (IRP) 310 module, an End-User World model (EWM) module 320, a Behavior Generation (BG) module 330, and a Value Assessment (VA) module 340.

The Input/Response Processing (IRP) 310 comprises an input processing (IP) component 315 and a response processing (RP) component 332. For simplicity the input processing 215 and response processing 232 modules are collectively referred to as the input/response processing module (IRP) 310. The IP 215 provides correlation, matching, and recognition of states, patterns, and events. Input 308 to the IEUG device 220 is produced by end-user interaction with the local network environment. Inputs 308 may include requests from various types of residential devices such as audio/visual equipment, computer-related equipment, and residential appliances. The inputs may involve such behavior as quantity of information requested, quality of information requested, need to use higher bandwidths, network impacts of end-user requests, types of services requested, time spent on the WAN network, etc. Inputs 308 to the IEUG 220 may also emanate from the direction of the WAN 100 as well. However, relative to their source, inputs 308 are used to monitor both the state of the external world and the internal state of the network system itself.

The collected inputs 308 are provided to the IP module 315, which compares input observations with expectations generated by the EWM 320. Input processing algorithms integrate similarities and differences between observations and expectations over time to detect events and recognize patterns and relationships in the world. The input data from a wide variety of sources over extended time-periods is fused into a consistent unified perception of the state of the world. Input processing algorithms compute several network system characteristics including both physical and logical attributes of objects and events of interest. For example, the translation of IP addresses using end user's input content and learning from the previous interactions with the network.

The response processing (RP) 332 within the IRP module 310 receives the results of executing behavior generation algorithms on the information stored in the end-user database 322 of the EWM 330. An example of response processing is the generation of composite bandwidth demand at the end-user node based on the sum-total of real-time activity from all local devices active at any point in time. IRP interaction (in conjunction with the BG and VA processes discussed below) with the EWM 320 containing traffic engineering rules and network element capacities, allows for development of optimized output responses 334 based on the dynamic synthesis of the real-time activities involved in a particular end-user request.

The end-user world model (EWM) module 320 responds to requests for information about the past, present, and possible future states of the environment. In conjunction with the value-assessment capability, the EWM module 320 is able to generate predictions per expected input values generated by the appropriate input-processing (IP) modules 310. In this role, the EWM module 320 generates predictions that enable the input processing system 310 to perform correlation and predictive filtering on a selective basis. For instance, during the process of local web browsing, end-user selected patterns of interest and preference are noted by the BG module 330 and hypothesized into a plan. This hypothetical plan information is passed on to the EWM module 320, which in turn generates predictions about the results of the end-user's current activity. The VA module 340 then evaluates these predictions as to their validity in terms of benefit, importance, and cost to the user using historical information from the EWM.

In addition to responding to requests from the corresponding BG module 330 at the end-user node level, the EWM 320 may also respond to requests from BG modules 330 at the WAN-level. For instance, as a starting point for capacity planning and network provisioning, local EWM modules 320 within the IEUG 220 are capable of responding to “What is” type-questions level from BG modules 330 at the WAN-level regarding current network device configurations at local end-user nodes. With regard to “What if” type-questions submitted by WAN network planners, local EWMs selected from several end-user nodes in a particular area or market segment may be utilized to furnish end-user information to simulate impacts to existing service of network designs optimized at the WAN level.

From a complimentary perspective, EWM modules 320 may also be utilized by WAN planners to reconfigure selected end-user networks, for purposes of simulating impacts of new end-user services/devices on existing WAN capacity/configurations. For both these processes, results predicted by simulations would be sent to the VA modules 340 at the WAN level for evaluation. Thus, for each BG hypothesized action, an EWM prediction is generated, and a VA evaluation is returned to the BG modules 330. This BG-EWM-VA coupling enables BG modules 330 to select the sequence of hypothesized actions producing the best evaluation as the plan to be executed.

The EWM 330 maintains a knowledge database 322 (e.g., local database) and keeps information regarding the end-user node current and consistent. The existing state of the local end-user network and its environment are reflected in the local database 322. The local database 322 includes the knowledge database (main memory and disk hard-drives) of the local network and its environment, plus a database management system that stores and retrieves information. The EWM module 320 has the capability to generate predictions about local network resources, operations, and usage and can respond to requests for information about past and present events as well as future expectations of the local end-user network environment.

Local information such as service profiles, device configurations, policy agreements, and the like are represented in various database structures contained with the local database 322. The local database 322 contains information about local end-user services, real-time demands, and local network devices as well as registering the outside network resources that would be required to fulfill end-user requests. These outside network resources could be (but not limited to) bandwidth required for a particular end-user service (either real-time or batched in the future) and any time-window constraints that might affect resource availability. The EWM 320 also contains knowledge of matters and information that are not directly and immediately observable. Rather, the EWM 320 is able to integrate input from different sources into a single request or preference.

As such, the local database 322 is updated based on correlation and differences between model predictions and input data submitted at the end-user node. The local data base 322 saves newly generated entities, states, and events in the knowledge database and deletes entities and states via the input processing modules 310, which no longer reflect the external world.

The Behavior Generation (BG) module 330 enables intelligent planning and behavioral choices. Behavior generation is the result of executing a series of tasks defined by such parameters as action, timing, and duration. A task refers to a segment of work to be completed or an activity to be performed usually beginning with a start-event and directed toward a goal-event. The BG module 330 within the IEUG device 220 is capable of selecting goals and plans, as well as executing tasks and decomposing task commands into subtask commands. Included in the definition of a task is “task knowledge”, that is, knowledge of how to perform a task including information as to what algorithms, protocols, parameters, time, events, resources, information, and conditions are required, along with information as to what costs, benefits and risks are expected. Task knowledge, which may be expressed implicitly in algorithms, software, and hardware, as well as expressed explicitly in data structures or in the EWM, has a variety of uses. The BG module 330 may use task knowledge for generating hypothesized actions, the EWM module 320 may use task knowledge for predicting the results of hypothesized actions, and the VA module 340 may use task knowledge for evaluating the importance of the goal as well resources to expend in pursuing such tasks.

A goal is an event that successfully terminates a task as well as the objective toward which task activity is directed. Goals are selected and plans are generated by the recursive interaction between behavior generation, local database modeling, and value assessment modules 340. The BG module 330 hypothesizes plans, the EWM module 320 predicts the results of those plans, and the VA module 340 evaluates those results. In addition to selecting plans with the highest evaluation for execution, the BG module 330 also monitors the execution of plans, and modifies existing plans whenever the situation requires. Input to BG module 330 may also consist of commands and priorities from to the BG module 330 itself, as well as evaluations from the VA module 340 along with information about past, present, and predicted future states of the environment from the EWM module 320. Output from the BG module 330 may consist of status reports plus “What Is?” and “What If” queries to the EWM module 330 about the current and future states of the environment.

The Value Assessment (VA) module 340 computes preferences, benefits, importance, and risks, among other value related assessments. The value assessment module 340 is used to determine the qualities associated with the events and actions involved in the intelligent network such as good, bad, importance, and risk. The value assessment module 340 evaluates both the observed state of the world and the predicted results of hypothesized plans. The VA module 340 computes costs, risks, and benefits both of observed situations and of planned activities. The VA module 340 computes the probability of correctness and assigns levels of credibility or validity to variables. The value assessment module 340 provides the basis for making decisions or for choosing one response over another. Without value assessment, any intelligence in a network would soon become obsolete by the intelligent network's own inappropriate actions. For instance, in deciding if a particular series of real-time end-user events is possible, the IEUG 220 must assess the WAN resources required. In addition to obtaining total bandwidth required for necessary services, plus historical information regarding WAN past ability to accommodate given requirements for timeframe and duration involved, a value assessment of network conditions is required before execution of the requested services could be recommended to the end-user.

Heuristic processes are designed so as not to evaluate the intrinsic interest of a communication service. Rather heuristic processes make available prioritized choices at first. In addition, some heuristic processes may be applied to multiple candidates, rather than all heuristic processes being applied to few candidates, since end-users usually prefer to interactively obtain a few recommendations very quickly. The heuristic processes within the IEUG 220 reduces reliance on preprogrammed knowledge representation to make decisions, and instead build domain knowledge incrementally as a result of inferences made from concrete actions of the end-user.

The IEUG 220 is able to detect responses from end-users to its messages such as read, file, or delete, and based on those responses, develop patterns of behavior, preferences, and wider networked activity that would eventually dovetail into service bandwidth demand. Thus, the IEUG 220 focuses between information retrieval and information-filtering paradigms. The end result may help in noticing serendipitous connections and providing guesses that would avoid dead-end or garden-path results.

Additionally, heuristic design techniques allow the IEUG 220 to take advantage of the different characteristics between itself and the end-users themselves. For instance, the end-user is slow at computation, while the IEUG 220 is much faster. The end-users have little short-term memory, but associative access to long-term memory. Furthermore, the end-user has vision and full natural language capability, while the IEUG 220 does not.

The IEUG device 220 is designed to gather information and assessing nodal activity at the end-user layer via proactive and dynamic optimization of available resources. A unified methodology for nodal intelligence enables this capability to be implemented. The methodology involves nodal activities, such as database representation of end-user nodes, to include information requirements of nodal services, the ability to monitor, capture, and process nodal input activity, as well as the ability to assess the value of nodal information flow either from direct input or derived from logical sub-processes. The methodology also includes the generation of composite behavior information per historical observation and current activity, and the development of optimized output responses based on dynamic synthesis of nodal activity.

The functions listed above require utilization of relational hierarchies with logical and temporal properties. In addition, the IEUG 220 has the capability to simulate the application growth-mix from new and different service demands in conjunction with varied utilization levels in order to determine future impacts to local resources and plan for their re-provision. This process also entails relevant information being made available to higher network node-levels allowing service-providers to evaluate overall impacts of end-user nodes to their network.

FIG. 4 depicts a flow diagram of dynamically interconnected layered network nodes representing the network of FIG. 1. In one embodiment, the end-to-end interconnected and layered intelligent network 100 comprises an end-to-end system level intelligence formed by a plurality of intelligence modules 300. Referring to FIGS. 1 and 4 together, each node (e.g., nodes 408₁ through 408ⱼ and nodes 403₁ through 403ₚ) at each horizontal layer (i.e., layers 110₁ through 110₈) has a corresponding “module” for providing the IRP 310, WM 320, BG 330, and VA 340, in a similar manner as discussed with regard to the IEUG 220 of FIG. 3. The nodes and respective modules aggregately form a system level intelligent network 100 by cumulatively interacting together in both a horizontal and vertical (end-to-end) hierarchically structure. In particular, FIG. 4 shows self-organizational capabilities of the network 100, and illustrates both the hierarchical and horizontal relationships involved, based on the discussions regarding FIGS. 1 and 3.

A plurality of hierarchal and horizontal nodes 402 though 408 are interconnected horizontally and vertically. For example, the management layer 110₈ comprises nodes 408₁ through 408ₖ, while the subordinate infrastructure provider layer 110₇ comprises nodes 307₁ through 307ₗ, and so forth down the hierarchal structure. It is noted that the number of nodes at each hierarchal layer 110 may vary. It is further noted that the end-user layer 110₁ is not shown in FIG. 4. Rather, the end-user layer 110₁ is considered part of the environment 350. As such, the IRP and BG modules 310₂ and 330₂ of the content layer 110₂ are shown as interfacing with the environment 350, rather than the end-user layer 110₁.

Each node at each hierarchal layer 110 is illustratively depicted by the four intelligence modules (i.e., the IRP module 310, the WM module 320, the BG module 330, and the VA module 340), as shown and discussed with regard to FIG. 3. For example, the infrastructure provider layer 110₇ comprises a plurality of nodes 407, through 407ₖ, where the first node 407₁ further comprises IRP module 310₇₁, the WM module 320₇₁, the BG module 330₇₁, and the VA module 340₇₁.

The architecture is hierarchical in that commands and status feedback flow hierarchically up and down a behavior generating chain of command. The architecture is also hierarchical in that input processing and world modeling functions have hierarchical levels of temporal and spatial aggregation. During network operation, goal driven switching mechanisms in the BG modules 330 assess aggregate priorities, negotiate for resources, and coordinate task activities to select among the possible communication paths. As a result, each BG module 330 accepts task commands from only one supervisory process at a time, and hence the BG modules form a command tree at every instant in time.

The architecture is horizontal in that data is shared horizontally between heterogeneous network functional modules at the same level. At each hierarchical level, the architecture is horizontally interconnected by communication pathways between the BG, WM, IRP, and VA modules in the same node, and between nodes at the same level, especially within the same command sub-tree.

An organization of processing nodes is shown in FIG. 4, such that the BG modules 330 form a command tree. The functional characteristic of the BG modules 330 at each level, the type of environmental attributes/entities recognized by the IRP modules 310 at each level, and the type of processing subsystems form the command tree. The specific configuration of the command tree is service and application dependent, and therefore not necessarily stationary in time.

FIG. 4 illustrates three possible dynamic configurations that may exist at different points in time. These different configurations are shown by links in three different line formats, which are associated with different time windows. During operation, relationships between the intelligence modules 300 within and between the hierarchal layers may be reconfigured in order to accomplish different goals, priorities, and task requirements. Accordingly, any particular computational node, with its BG, WM, IRP, and VA modules, may belong to one subsystem at one time and a different subsystem a short time later. These configurations are obtained by the application of automated planning processes and the information collected from the spatial-temporal properties of the network elements and the network environment.

The command tree reconfiguration may be implemented through multiple pathways that exist, but are not always activated, between the BG modules 330 at different hierarchical levels. These multiple pathways define a layered graph of nodes and directed arcs. They enable each BG module 330 to receive input messages and parameters from several different sources.

As discussed above, each layer of the system architecture contains a number of nodes, each of which contains BG, WM, IRP, and VA modules, and the nodes are interconnected as a layered graph, through the management communication network system. The nodes are richly but not fully, interconnected.

In an all-optical DWDM network elements layer illustratively shown in FIGS. 1 and 4, some of the outputs from the BG modules 330 drive the micro-mechanical mirror motor actuators, while the inputs to the layer IRP modules 310 convey data from the environment. During operation, goal driven communication path selection mechanisms configure this lattice structure into the organization tree shown as shown in FIG. 4. The IRP modules 310 are also organized as a layered graph. At each higher level, input information is processed into increasingly higher levels of abstraction, as input processing pathways may branch and merge in different ways.

For a better understanding of the invention, a few examples of specific layers and their functioning in a self-organizing network is provided. The Management layer 110₈ plans activities and allocates resources for one or more subordinate layers (e.g., layers 110₇ through 110₁) for a period specified in the historical trace patterns. At the management layer 110₈, requests for provisioning, bandwidth orders, and the like are consolidated into batches for optimal resource utilization, and a schedule is generated for the layer(s) to process the batches.

Additionally, at the management layer, the WM 320 maintains a knowledge database 322 containing names, contents, and attributes of batches and the inventory of resources required to provide the requested bandwidth and services. Historical traces may describe the temporal bindings of services, routing and bandwidth between nodes. The IRP 310 processes compute information about the flow of services, the layer of inventory, and the operational status of all the nodes involved in the network 100. The VA module 340₈ computes the cost and benefits of various batches and routing options and calculates statistical service confidence data.

An operator interface allows service provider technicians to visualize the status of bandwidth and service requests, inventory, the flow of resources, and the overall situation within the entire network. Operators can intervene to change priorities and redirect the flow of resources and services. Planners keep track of how well plans are being followed, and modify parameters as necessary to keep on plan. The output from the management layer provides workflow assignments for the underlying nodes.

Regarding the application layer of intelligence 110₃, one of the functions of the VA modules 340 that support the application layer of intelligence 110₃ is to provide the WM and BG modules 320₃ and 330₃ with ratings report for the applications at regular intervals of time. This information allows the BG modules 330 to isolate applications, which were used by more end-users than any other application on their network, on demand. This type of on-demand ratings generation capability of applications provides a service provider with a competitive edge, where a service provider can change the subscription plans to increase their bottom-line and redirect their other unused resources to support these high-flying applications.

In an end-to-end intelligent network 100, intelligence in an end-user device (end-user layer 110₁), when integrated properly with the other intelligent layers, plays a major role by contributing and utilizing of the intelligence in a network. The importance of the end-user layer 110₁ is significant because the amount of end-user behavioral information generated can be controlled at the end-user layer 110₁, where it originates, so that only useful information is communicated to the other layers of the intelligent network 100.

In this context, the IEUG device 220 is integrated with intelligence gathering functionality, where the IEUG device 220 monitors the end-user needs, as well as behavioral patterns, and encodes the information into a data structure called an end-user diary. These intelligence-gathering mechanisms can automatically and invisibly keep track of the end-user(s) functions without creating an overhead on the network. The information collected is processed and communicated securely to the other intelligent network layers when the traffic on the network is minimal (e.g., during the nights).

The IEUG device 220 provides capabilities needed at the user's premises not normally considered part of the service providers' networks. The IEUG device 220 permits expanded intelligence within the equipment deployed on the customer premises and requires additional functionality and coordination within the service provider space. The importance of the end-user intelligence layer 110₁ is significant because the amount of end-user behavioral information generated may be controlled at the layer where it originates, such that only useful information is communicated to the other layers of the intelligent network 100. The IEUG device 220 is integrated with intelligence gathering functionality, where it monitors the end-user needs and behavioral patterns, and encodes the information into a data structure likened to an end-user diary. As such, the IEUG device 220 is useful in providing content to the user premises in anticipation of user needs, as well as at times of lower utilization on the service provider's network. Additionally, intelligence at the end-user's layer 110₁ is important in supporting new services that are tailored to the usage patterns and interests of the users.

The intelligence-gathering modules 300 automatically and invisibly keep track of the end-user(s) functions without creating an overhead on the network 100, as collected information is processed and communicated securely to the other intelligent network layers when traffic on the network is minimal (e.g., during the nights). Intelligent network management layers 110₈ at the WAN-level query all the end-user diaries, and update the nodes of the network management layers' 110₈ user-profile database with the necessary information. In return, the nodes of the network management layers 110₈ send each end-user IEUG device 220 information, illustratively regarding the predicted traffic load on the network layers for the following day based on expected end-user service needs for the next day. The status of the network information allows the behavior generation modules 330 to make better choices in selecting network routes and application servers among the available alternatives for service.

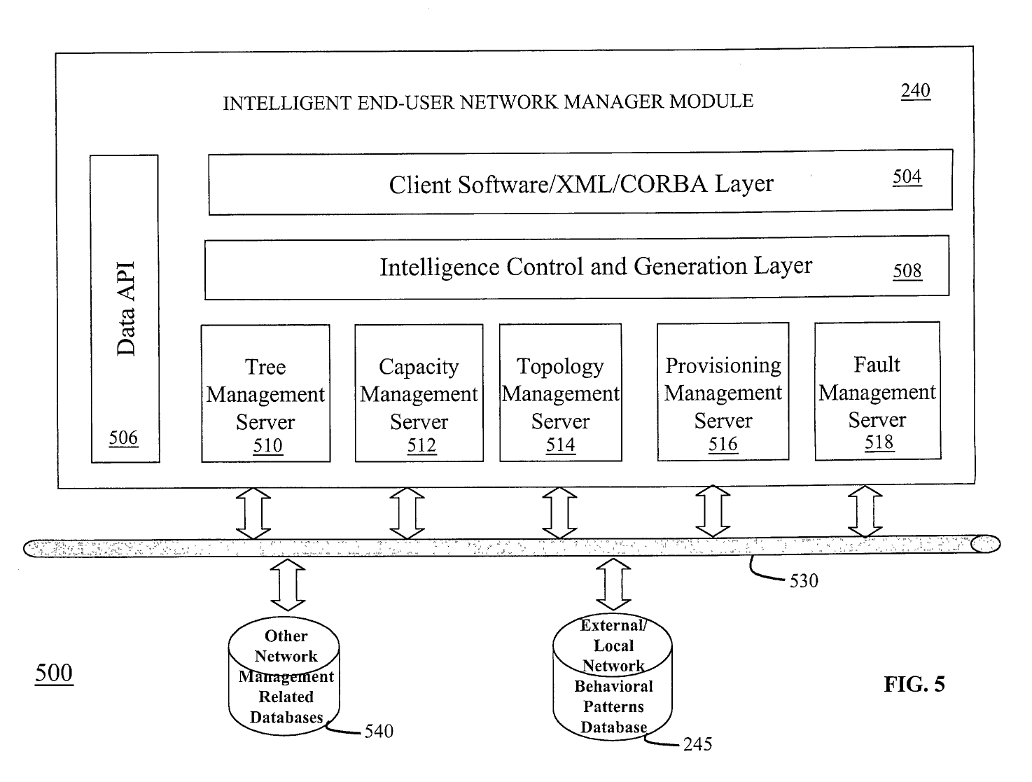

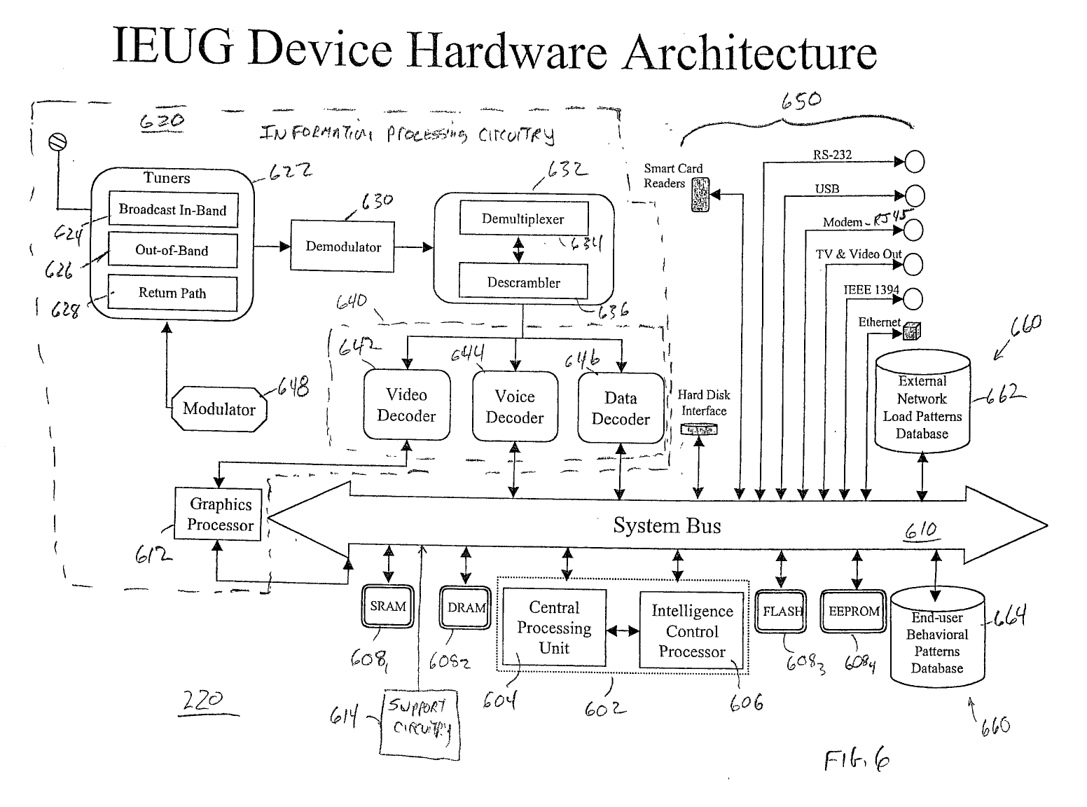

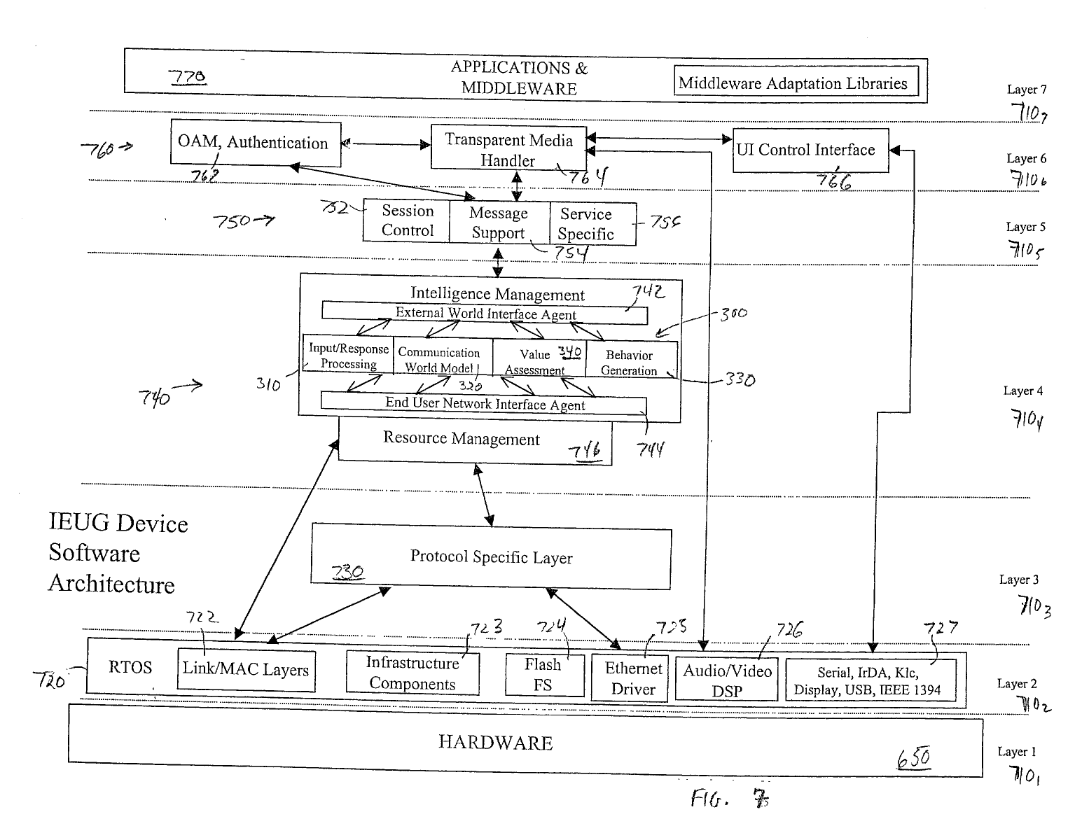

FIG. 5 depicts a high-level block diagram of an intelligent management system 500 of the IEUG of FIG. 2. In order to accomplish its mission, the IEUG 220 requires the logical interaction of database information and interdependent processes, linked together in open-layered architectures to enable hardware/software components of the IEUG 220 to communicate in a controlled and intelligent manner to achieve the desired result. The Intelligent Management System Architecture of FIG. 5 operating in conjunction with the hardware/software architectures of the IEUG 220 (see FIGS. 6 and 7) provide services that make the IEUG device 220 behave like a virtual common entity in response to queries and updates from the end-user. Thus, intelligence displayed within the IEUG 220 is not bound by the narrow limits imposed by static and reactive network models.

Referring to FIG. 5, the intelligent management system architecture 500 comprises an intelligent end-user network management module 240, a high-speed bus 530, lightweight directory access protocol (LDAP) based network management databases 540, and a network temporal behavior database 245. The intelligent end-user network management module 240 bi-directionally communicates with the LADP directory database 540 and the network temporal behavior database 245 through the high-speed bus 530.

The intelligent end-user network management module 240 comprises client software and XML/CORBA (extensible markup language/common object request broker architecture) layer 504, a data application programming interface (API) 506, Intelligence Generation and Control layer 508, a tree management server 510, a capacity management server 512, a topology management server 514, a provisioning management server 516, and a fault management server 518.

In operation, the intelligent end-user network management module 240 monitors the customer premise hardware environment 250 and the IEUG 220 device. The Tree management Server 510 module intelligently monitors and manages the end user device dependencies and interactions. The Capacity Management Server 512 module intelligently monitors and manages the customer premise hardware environment network node's ,capacity management issues. The Topology Management Server module 514 intelligently monitors and manages the customer premise hardware environment network topology 250 and interactions with external networks using the data APIs 506. The Provisioning Management Server 516 intelligently monitors and manages the customer premise hardware environment network node 250 dynamic and static provisioning issues. The Fault Management Server 518 intelligently monitors and manages the customer premise hardware environment 250 faults. Each server module 510, 512, 514, 516, and 518 in the intelligent end-user network management module 240 collects the interactions they have with the external network via data APIs 506 and the customer premise hardware environment 250.

The Intelligence Generation and Control Layer 508 processes this information using learning algorithms and stores the processed information in the External/Local Network Temporal Behavior Database 245. This information is shared with the intelligent end-user network management module 240, Local Network Behavior Patterns Memory 245₁, and External Network Behavioral Model Memory 245₂ in the IEUG device 220.

FIG. 6 depicts a detailed block diagram of the IEUG device 220 hardware architecture. The IEUG device 220 may be considered a general-purpose computer device such as a server, workstation, or desktop computer. The IEUG 220 comprises one or more processors 602, memory 608, at least one system bus 610, a graphics processor 612, support circuitry 614, a plurality of I/O interface ports 650, and information processing circuitry 620.

Specifically, the IEUG 220 of FIG. 6 comprises at least one processor 602 as well as memory 608 for storing various control programs and databases 660. In one embodiment, the at least one processor 602 comprises a central processing unit (CPU) 604 and an intelligence control processor (ICP) 606. Both exemplary processors 602 cooperate, via the at least one system bus 610, with conventional support circuitry 614, such as power supplies, clock circuits, cache memory, and the like, as well as circuits that assist in executing the software routines stored in the memory 608.

In the exemplary embodiment of FIG. 6, the functions typically provided by the CPU 604 include initialization of the various IEUG device hardware components, processing a range of Internet and interactive TV applications, monitoring and managing hardware interrupts, retrieving data and instructions from memory 608, and running various programs. The ICP 606 functions as the intelligent gathering and execution element of the IEUG device 220. Some illustrative functions typically provided by the ICP 606 include monitoring and managing end user needs (services), learning end user behavioral patterns and storing such patterns in memory, analyzing service provider network behavior, communicating back and forth with the service provider network intelligent components, and pre-planning service scenarios in anticipation of the end user needs from the historical traces. Moreover, it is contemplated that some of the process steps discussed herein as software processes may be implemented within hardware, for example as circuitry that cooperates with the intelligence control processor (ICP) 606 to perform various steps.

The memory 608 includes volatile memory such as SRAM 608₁ and DRAM 608₂. The volatile memory 608 is used as a temporary storage area for data flowing between the processor and the various hardware components. For example, the graphics processor 612, video decoder 642, and de-scrambler 636 each require a certain amount of memory 608 to fulfill their specific functions within the IEUG device 220. Additionally, non-volatile memory such as read-only memory (ROM) (e.g., flash memory 608₃ and EEPROM's 608₄) may also be utilized to store various program codes.

The IEUG device 220 has the ability to locally store and retrieve information to support high quality end user of networking technologies. In one embodiment, hard disks are integrated within the IEUG device 220. Alternately, an external storage device may be coupled to the IEUG 220 through the USB or IEEE 1394 data interfaces 650. Other permanent storage devices such as cdroms, tape drives, magneto optical drives, and the like may also be utilized to permanently store various program code, application programs, as well as content and data.

The information processing circuitry 620 comprises a tuner module 622, a downstream demodulator 630, a demultiplexer/descrabler module 632, a plurality of information decoders 640, a graphics processor 612, and an upstream modulator 648. The tuner module 640 is available for accessing QAM, OFDM, and QPSK-based networks. In particular, the tuner module 622 comprises at least one of a broadcast in-band (IB) tuner 624 and/or an Out-of-band (OOB) tuner 626. The broadcast in-band (IB) tuner 624 receives a signal from the physical transmission media, isolates a physical channel (e.g., TV channel) from a plurality of channels, and converts the physical channel to a base-band signal. The Out-of-band (OOB) tuner 626 facilitates the transfer of data between the customer premise hardware environment 250 (e.g., an in-home system) and broadband network servers.

The base-band output signal from the tuner is forwarded to the demodulator 630. The demodulator 630 samples the incoming baseband signal and converts the baseband signal into a digital bit-stream. The bit-stream contains video, audio, and data. Once the bit stream is recovered, the bit-stream is checked for errors and forwarded to the demultiplexer/descrabler module 632, which comprises a demultiplexer 634 coupled to a descrabler 636.

A standard MPEG-2 data stream will consist of a number of uniquely identified data packets. MPEG-2 uses an identifier called a Packet ID (PID) that identifies a packet as containing a particular format of data-audio, video, or interactive services. In one embodiment, the demultiplexer 634 is an application specific integrated circuit (ASIC) chipset that examines every PID and selects, decrypts, and forwards particular packets to a specific decoder 640. The descrambler 636 (i.e., decryption unit) is based on complex security algorithms that prevent unauthorized users from viewing programs or accessing Internet-based services. The exact details of the decryption process are programmable, and typically operator-specific.

In one embodiment, the digital IEUG device 220 comprises three separate decoders 640 for converting the digital bit stream into a format that can be heard and viewed by the subscriber. In particular, a video decoder 642 transforms the video packets into a sequence of pictures, which may be displayed on a TV monitor. Furthermore, the graphics processor 612 provides a range of Internet file formats and proprietary interactive TV file formats.

The compressed audio bit stream is sent to an audio decoder 644 for decompression. Once the MPEG-2 bit stream is decompressed, it is presented to a set of speakers on the network. The audio decoder 644 is used to forward the data to a high-speed interface port that is connected to the in-home network. Furthermore, packets with a data PID are forwarded to the data decoder 646 for further processing.

The information processing circuitry 620 also contains upstream processing circuitry. In particular, signals received from the CPE 250 are sent to the modulator 648 to modulate and deliver an upstream signal to the return path tuner 628. The return path tuner 628 forwards the modulated upstream signals to, for example, a service provider to provide interactive services.

The IEUG 220 also contains input/output (I/O) circuitry 650 that forms an interface between the various functional elements communicating with the IEUG 220. For example, the IEUG 220 illustratively comprises a set of device interfaces 650, such as Ethernet, USB, ISDN, Parallel Port, RS-232, RJ45, RJ11, IEEE 1394, Infrared, SCSI, IDE, PCMCIA, and the like on the end-user side, as well as various network side interfaces, such as air interface, coaxial interface, twisted pair interface, fiber interface, among others.

In particular, the RS232 Serial Interface uses a D-connector (e.g., nine pin D-connector), which allows connectivity to serial printers, computers, and standard telephone modems. TV and VCR Interfaces of the IEUG device 202 communicate with A/V devices on an end user network through two output ports (e.g., Scart connectors). In an end user networking environment, modems may be added to IEUG device 202 to facilitate the implementation of two-way interactive services, such as interactive services over the Internet. Once activated, the modem can use the return path 628 for sending requests to web servers on the Internet, thereby enabling IEUG device users to upload files, send e-mail, and facilitate two-way interactive TV services, such as video on demand.

In one embodiment, the IEUG device 220 contains slots to optionally accommodate smart cards that authorize end users access to various digital services and e-commerce applications. Furthermore, the I/O interface ports 650 such as the IEEE 1284 parallel port, USB, IEEE 1394 (Fire-Wire Bus Interface Standard), and Ethernet, allow the IEUG device 220 to takes advantage of high-speed data transfer technologies to communicate in real time with devices such as Camcorders, DVDs, CD players, mixing consoles, and music keyboards.

Moreover, the common interface (CI) may optionally be provided to the IEUG device 220 to accept Personal Computer Memory Card International Association (PCMCIA) cards or modules. PCMCIA cards or modules allow for the expansion of various IEUG device 202 capabilities, such as extending the memory capabilities, networking different CPE systems within the home, adding hard disk capacity, adding new tuners, as well as wireless capabilities, such as those defined under the Bluetooth standards.

Accordingly, the main features of the IEUG device 220 include decoding incoming data, video, and voice digital signals, verifying access rights and security levels, and communicating to designated network nodes in the service provider network, such as network management nodes. Additional features include compiling end user diaries, generating profiles regarding end user behavior, usage, and needs, as well as receiving and storing the service providers network node profiles, planning for end user services needs for the immediate future, and deriving the plans from the past historical patterns. Moreover, the IEUG device 220 shares the planned information to the service providers intelligent network nodes, learns new patterns and updates existing patterns, based on risk analysis, and provides advanced planning/programming information into future (e.g., 1 day, 7 days, 1 month, etc.).

FIG. 7 depicts a block diagram of the software architecture of the IEUG device 220. The software architecture of the integrated IEUG device abstracts out the hardware, signaling, user interface, and several other components. That is, the software architecture allows a uniform interface while hiding IEUG related protocols, and other hardware specific details. This abstraction provides a uniform view of the underlying integrated system and allows rapid development of new applications for the proposed integrated IEUG device 220.

In one embodiment, different layers are used in the software architecture of the integrated IEUG to achieve this abstraction. Referring to FIG. 7, seven layers 710₁, through 710₇ are illustratively shown depicting the organizational structure of the IEUG device 202, when integrated into the intelligent network system 100. It is noted that these seven layers are not specifically correlated to the Open Systems Interconnection (OSI) networking model.

The first layer 110₁ is hardware specific and defines the physical means of sending data over physical communication lines (i.e., electrical, mechanical, and functional control of data circuits). The hardware of the first layer 110₁ was described in detail with regard to FIG. 6 above.

The second layer 110₂ is protocol specific and comprises real-time operating system and hardware abstraction features. The real-time operating system (RTOS) features 720 includes task-priority, preemption, and timers, along with various drivers. The software architecture is in itself, operating system independent. The second (RTOS) layer 110₂ comprises operating system specific software components to provide operating system adaptation, as well as drivers for various physical layers (e.g., Ethernet drivers 725 and the like). The software architecture for the IEUG 220 also contains the Ethernet physical layers. The RTOS layer 720 also provides standard interfaces such as the DSP interface 726, memory management and interface, and interfaces to other peripheral components 727, such as the serial driver, IrDA, USB, among others. The hardware APIs, device support library components, and device libraries provide hardware abstraction. The infrastructure components 723 provide global software services to the IEUG device 202. The OS abstraction library is a key component of the infrastructure, which provides a common API and semantics for all RTOS calls performed within the IEUG architecture. The ROTS layer 720 includes a link/media access control (MAC) 722 layer, which controls access to the IEUG physical layer. Flash memory management software 724 allows easy upgradability of IEUG device 220, since changes to standards or protocol can be reprogrammed in blocks instead of one byte at a time.

The third layer 710₃ is protocol specific and comprises the standard TCP-UDP/IP stack, along with the specific protocol implementations depending on the context in which the IEUG device is used. For example, when the IEUG 220 is used as the high-speed mobility end user device, the Mobile IP standard protocol is used. In one embodiment an RTP component for media transfer is utilized.

The fourth layer 710₄ is an intelligent resource management layer, which comprises intelligent resource management components 740, which interact with the lower the second layer 710₂ (e.g., the Ethernet subsystem) and the fifth device server layer 710₅. The intelligent resource management component 740 comprises the intelligence modules 300 (i.e., the IRP, CWM, VA and BG modules 310, 320, 340, and 330), an external world interface agent 742, an end-user network interface agent 744, and a resource management component 746

The intelligent resource management component 740, along with session control, message support and other services (752, 754, and 756 of the fifth layer 710₅) is used in setting up of services between a service providers network, and the IEUG 220. The intelligent resource management component 740, along with session control 752, is used to setup and tear down sessions, as well as to support advanced intelligence services. One major difference between the IEUG intelligent resource management 740 and a conventional resource management system, is that the fourth layer 110₄ of the IEUG device 220 uses the past history and the information obtained from the other network nodes in making the intelligent decisions. The end user interface agent 744 and external network interface agent 742 handle the end-user and the external network intelligent functions independently. These interface agents (742 and 744) use the IRP, CWM, VA and BG modules 310, 320, 340, and 330 in processing end user and network intelligence, as discussed and shown with regard to FIG. 3.

The fifth layer 710₅ and comprises device servers for the IEUG 220 and is referred to as the device server layer. In particular, the fifth layer 710₅ comprises a session control component 752, a message support component 754, and a service specific component 756. Along with the resource management component 746, the session control 752, message support 754, and service specific 756 management components (e.g., mobility management) are used in setting up services between a service providers network 110₅ and the IEUG 220.

The sixth layer 710₆ is a transparent media layer 760 that provides a unique abstraction of the underlying components to the seventh layer 710₇, which is the middleware and applications layer as discussed below. In particular, the sixth layer 710₆ is a transparent media layer 760, which provides a uniform interface for the layers below the applications in the above layer 710₇. The sixth layer 710₆ abstracts out the idea of integrating/combining the end user network functions with that of the external network intelligence needs.

The sixth layer 710₆ comprises an operations/administration/management (OAM) component 762, a transparent media handler 764, and a user interface (UI) control interface 766. In particular, The OAM component 762 handles operations, administration, and management issues, which includes fault management, and other SNMP functions, codec compression, service planning, security, and other services. Specifically, the management component 762 of the transparent media layer 760 initiates the initialization and registration of the IEUG 220 with both the end user network and the external network components. The management component 762 also maintains the state of both the connections.

The transparent media handler 764 manages the media of transmission. That is, the transparent media handler 764 manages important functions of the IEUG 220, such as negotiating codecs, selecting different compression techniques, mixing data-streams, performing authentication, and various other features. One may also use resources, such as new compression techniques, plans, profiles, and the like from the device server 740 in the IEUG device server and vice-versa. Additionally, the UI control interface 766 gives applications access to the UI peripherals of the IEUG 220.

The seventh layer 710₇ is an application layer 770, which provides transparent multi-media applications to the end user. The application layer 770 comprises middleware adaptation libraries 772, which support popular middleware programs.

The application layer 770 allows rapid development of applications for the IEUG 220 through the APIs provided by the transparent media layer 760. These APIs with the separation of details from the device server layer 750 and the transparent media layer 760 provide the necessary abstraction for new applications that take advantage unique interface of the IEUG 220.

It may be appreciated that the end-user node-level functions with the IEUG device 220 are significantly advanced from traditional end-user activities. For example, IEUG processes are not idle while various end-user tasks are being executed. Traditional end-user agents replace “browsing” with “searching”, while the IEUG device 220 replaces “searching” with “browsing”. The IEUG device 220 can maintain persistence of interest over time, while traditional web-processes must re-instate interest at each session. Division of labor between the IEUG 220 and end-user is dynamic. IEUG behavioral patterns are stored, encrypted, and communicated securely to other nodes. Furthermore, the IEUG 220 separates data collected from end user name/address interfering with end user privacy.

The intelligence gathered at the IEUG device emanates from the monitoring of end-user content requirements, as well as search and usage patterns and interests. In order to develop the necessary traffic/throughput demands required for current and new services, the IEUG records end-user actions and is able to determine end-user intent, interests and preferences from knowledge-based content inferences per end-user browsing behavior.

For instance, from sequences of browsing events, the IEUG device 220 may infer areas of interest such that selection of links indicate interests, whereas passing over links would indicate disinterest. While the end-user could be reading one web-page, the IEUG 220 is capable of searching other nearby links or monitoring the web-browsing process to learn topics of interest to the end-user as well as scanning the neighborhood of the web page to discover other pages the end-user may wish to access next. The IEUG 2220 is capable of suggesting links currently available to the end-user might be of the most interest. Similarly, the IEUG 220 is able to interact with other applications and devices in providing high-quality end-user service. Thus, the IEUG 220 is able to share tasks and results, work concurrently with other devices, as well as sharing resources. The IEUG device 220 is also capable of providing graphical feedback to end-users, as well as learning from observation and communication with other agents at the end-user node, such as a PC, other devices, and the end-users themselves.

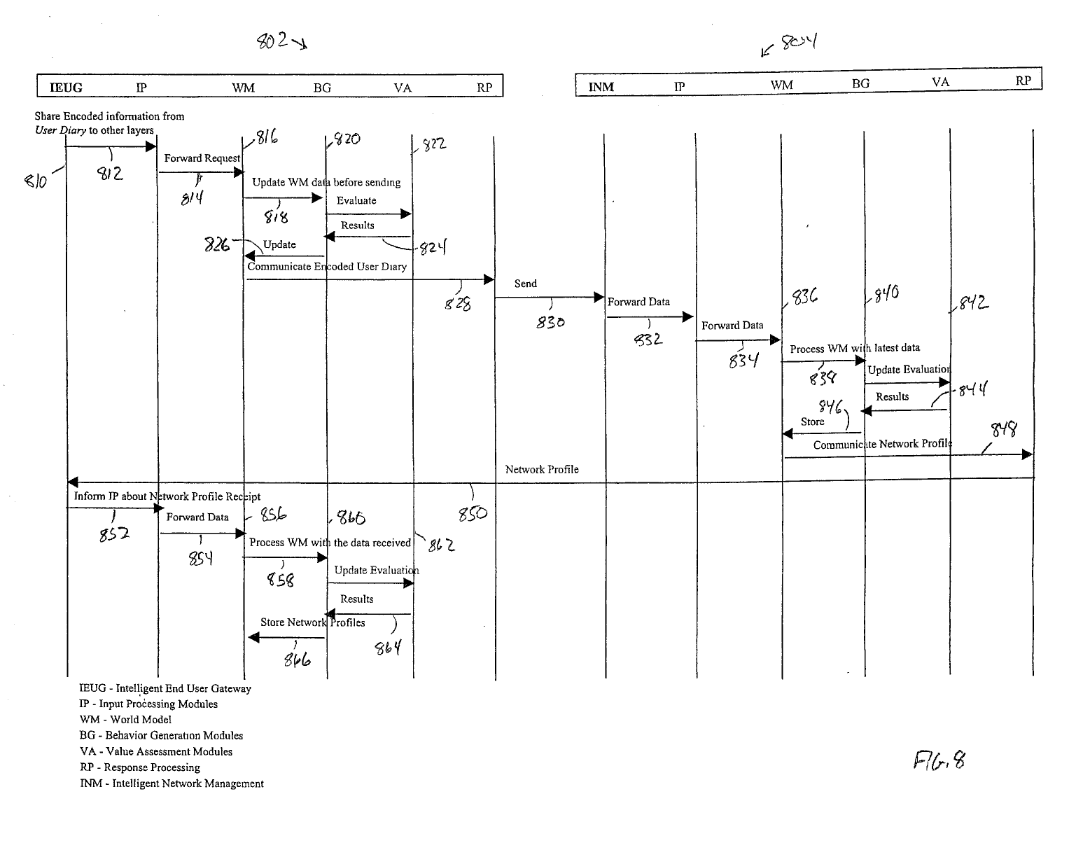

FIG. 8 depicts a flow diagram representing intelligence update control flow between end-user gateway device and the network management layer 110₈. That is, FIG. 8 depicts the intelligence exchange flow between the IRP-WM-BG-VA modules of the intelligent residential gateway and an intelligent network management layer IRP-WM-BG-VA modules. An IEUG device 220 and its respective intelligence modules 300 (i.e., IP, WM, BG, VA and RP modules) are shown under column 802 on the left side of FIG. 8. Similarly, the intelligent network management (INM) layer 110₈ and its respective intelligence modules (i.e., IP, WM, BG, VA and RP modules) are shown under column 804 on the right side of FIG. 8.

The intelligent network management layer 110₈ receives all the end-user diaries and updates the user profile database. In return the intelligent network management layer 110₈ sends each end-user gateway device, information about the predicted traffic load on the network layers, illustratively for the following day based on expected end-user service needs for the next day. The status of the network information allows the behavior generation modules of the intelligent network management layer 110₈ to make better choices in selecting network routes and application servers among the available alternatives for service.

In particular, at step 810, the IEUG device 220 encodes an end-user information request into the end-user diary and at step 812, the encoded information is sent to the input processing (IP) module 315₁ of the IRP module 310, which forwards the request for information, at step 814, to the WM module 320₁. At step 816, the WM module 320₁ is updated, as discussed with regard to FIG. 3, and at step 818, the information is sent to the BG module 330₁. At step 820, the BG module 330₁ selects goals, initiating plans, and executing tasks and subtasks to achieve the goals within the plans.

At step 822, the VA module 340₁ evaluates both the observed state of the world and the predicted results of hypothesized plans. That is, the value assessment module 340₁ computes costs, risks, and benefits both of observed situations and of planned activities, as well as the probability of correctness and assigns believability and uncertainty parameters to state variables.

At step 824, the results of the VA module 340₁ are sent back to the BG module 330₁, where particular plans and tasks are selected. At step 826, the WM module 320₁ is updated with newly generated/recognized entities, states, and events, which are stored in the knowledge database 222. At step 828, the RP module 234 receives the updated encoded user diary containing the end-user needs and behavioral patterns, as well as the plans and tasks generated by the BG and VA modules 330₁ and 340₁. At step 830, the updated encoded user diary (data) is sent to the INM hierarchy layer 110₈.

In particular, at step 832, the data is sent to the input processing (IP) module 315₈ of the IRP module 310 310₈ of the network management layer 110₈. Steps 834 through 848 are performed at the network management layer 110₈ in the same manner as described with regard to the IEUG device 220 in steps 814 through 828. At step 850, the results from network management layer 110₈ are sent back to the IEUG device 220.

At step 852, the data from the network management layer 110₈ is sent to the input processing (IP) module 315₈ of the IRP module 310₈ of the IEUG device 220. Steps 854 through 866 are performed at the IEUG device 220 in the same manner as described with regard to the IEUG device 220 in steps 814 through 826.

It is noted that within the proposed framework, each layer would control and resolve issues within its purview. At each layer, the inputs and requests are received and reactions are planned by the input processing module, evaluated according to the world model by the value assessment engine and implemented by the behavior generation subsystem. In the above example, the network management layer 110₈ creates and modifies the networking and subnet structure and assigns end-users within that structure to provide the most reasonable administrative structure according to the rules and policies of the service provider.

The specific functions given in the above examples are for illustrative purposes only. The process steps between the IEUG device 220 and the nodes of the network management layer 110₈ are shown to illustrate intelligence flow between two network layers 110. However, the example set forth in FIG. 8 may alternately include intelligence flow between any two layers 110 (e.g., the service provider layer 110₅ and the network management layer 110₈ or the service provider layer 110₅ and the infrastructure provider layer 110₇). The examples are meant only to illustrate how the generic structure and function of the network framework might be instantiated by a service provider. The purpose of these examples is to illustrate how multi-level hierarchical architecture integrates real-time planning and execution behavior with dynamic world modeling, knowledge representation, and input. At each level, behavior generation 330 is guided by value assessments that optimize plans and evaluate results. The IEUG device architecture, in combination with the intelligent network 100, organizes the planning of behavior, the control of action, and the focusing of computational resources.

The overall result is an intelligent real-time self-organizing network system 100 that is driven by high-level goals and reactive to input feedback. One benefit of the IEUG device 220 is to enable end-users to efficiently utilize the network resources based on end-user needs that are dependent on the spatial-temporal changes in the network 100, itself, and changes in network environment 250.

Although various embodiments that incorporate the teachings of the present invention have been shown and described in detail herein, those skilled in the art can readily devise many other varied embodiments that still incorporate these teachings.

What is claimed is:

1. A method of providing network intelligence between an intelligent end-user gateway (IEUG) device and a plurality of intelligent network layers, comprising:
a) generating an end-user diary including goals, goal-related plans, and tasks to fulfill the plans;
b) forwarding said end-user diary to at least one of said plurality of intelligent network layers;
c) updating a user profile from said end-user diary at said at least one of said plurality of intelligent network layers;
d) sending goal related information to said IEUG device; and
e) performing said tasks and plans to fulfill said goals based on said network related information.

2. The method of claim 1, wherein said generating step a) comprises:
a1) encoding an end-user information request into said end-user diary;
a2) updating a world model regarding the network environment;
a3) generating said goals, plans and tasks to achieve said goals;
a4) evaluating said goals, plans, and tasks;
a5) selecting particular goals, plans, and tasks of said evaluated goals, plans, and tasks;
a6) updating said world model regarding said selected goals, plans, and tasks; and
a7) updating said end-user diary including said selected goals, plans, and tasks.

3. The method of claim 2, wherein said updating the world model step a2) comprises storing information regarding local end-user network and environment information.

4. The method of claim 2, wherein said updating the world model step a2) comprises generating predictions regarding local network resources, operations, and usages.

5. The method of claim 2, wherein said generating said goals, plans, and tasks step a3) comprises:
generating hypothesized plans;
predict results of said hypothesized plans;
evaluate the predicted results of said plans;
selecting hypothesized plans having highest evaluation; and
selecting tasks to achieve said selected plans.

6. The method of claim 5, wherein said evaluating step a4) comprises determining preferences, benefits, importance, risks, costs of an existing state of said world model and predicted results of said hypothesized plans.

7. The method of claim 2, wherein the updating a user profile step c) comprises implementing steps a1 through a7 at each of the plurality of intelligent network layers receiving said end-user diary.

8. The method of claim 7, wherein after receiving said network related information of step d) said method comprises repeating steps a1 through a6 by the IEUG device.

9. The method of claim 8, wherein said performing step e) comprises selecting network routes and application servers among available alternatives for service.

10. An intelligent end-user gateway (IEUG) device for providing end-user device intelligence to an intelligent network, comprising:
a plurality of functional layers for providing respective functions within a hierarchy of functions, each of said functional layers including a respective agent for vertically propagating information between hierarchically adjacent layers, each of said functional layers including at least one element for implementing at least one respective layer function; wherein
each functional layer agent, in response to a respective task-indicative subset of said vertically propagated information, horizontally propagating to respective functional layer elements at least that information necessary to perform an indicated task; and
each functional layer agent vertically propagating information pertaining to said indicated task.

11. The IEUG device of claim 10, wherein said plurality of functional layers comprises:
a first hardware layer;
a second real-time operating system (RTOS) layer adjacent and interfacing with said hardware layer;
a third protocol layer adjacent and interfacing with said second real-time operating system layer;
a fourth intelligent resource management layer adjacent and interfacing with said third protocol layer, said fourth intelligent resource management layer further interfacing with said second real-time operating system layer;
a fifth device server layer adjacent and interfacing with said fourth intelligent resource management layer;
a sixth media layer adjacent and interfacing with said fifth device server layer, said sixth media layer further interfacing with said second real-time operating system layer; and
a seventh application layer adjacent and interfacing with said sixth media layer.

12. The IEUG device of claim 11, wherein said second RTOS layer further comprises operating system specific software and a plurality of drivers.

13. The IEUG device of claim 11, wherein said third protocol layer further comprises a TCP-UDP/IP stack and specific protocol implementations.

14. The IEUG device of claim 11, wherein said fourth intelligent resource management layer comprises intelligence modules having an input and response (IRP) module, a world model (WM) module, a behavioral generation (BG) module, and a value assessment (VA) module in communication with each other.

15. The intelligent network of claim 14, wherein said IRP module receives inputs to the intelligent network system, compares input observations with expectations generated by the WM module, and communicates observed entities, events, and perceived situations to the VA modules.

16. The intelligent network of claim 15, wherein the BG module hypothesizes plans, the WM module predicts results of such plans, and the VA module evaluates those results.

17. The intelligent network of claim 16, wherein said WM module further comprises a database for storing information regarding about the network and network environment.

18. The intelligent network of claim 17, wherein said WM module generates expectations and predictions about network resources, operations, usage; and responds to requests for information about present, past, and probable future states of the world.

19. The intelligent network of claim 18, wherein said IRP, WM, BG and VA modules contribute to a hierarchal intelligence across the network.

20. The intelligent network of claim 19, wherein the intelligence modules at each node utilize historical information gathered as each node to formulate decisions for future actions.

21. The intelligent network of claim 20, wherein the intelligence modules select goals and plans, and executes tasks, said tasks are recursively decomposed into subtasks, and said subtasks are sequenced to achieve said goals.

22. The IEUG device of claim 11, wherein said fifth device server layer comprises:
a session control element;
a message support element; and
a service specific element; wherein said session control, message support, and service specific elements establish services between said IEUG device and a service provider.

23. The IEUG device of claim 22, wherein said sixth media layer comprises:
an operations/administration/management (OAM) element interfacing with said message support element;
a media handler interfacing with said OAM element, said message support element, and said second RTOS layer; and
a user interface element interfacing with said media handler and said second RTOS layer.

24. The IEUG device of claim 11, wherein said seventh application layer comprises a plurality of middleware abstraction libraries for supporting middleware.

25. A method of providing intelligence to end-user devices communicating with a network having a plurality of network layers, at each layer said method comprising:
a) establishing goals to be performed by an intelligent end-user gateway (IEUG) device coupled to said end-user devices at a first network layer;
b) providing input to a database storing information regarding the network and network environment;
c) hypothesizing plans to accomplish said goals at said IEUG device;
d) predicting results of said hypothesized plans;
e) evaluating said predicted results;
f) selecting plans with the highest evaluations for execution;
g) updating said database;
h) sending an output response to at least one of a superior and subordinate layer to said first layer;
i) repeating steps a through h for all of the network layers; and
j) executing said selected plans.

26. The method of claim 25, further comprising:
monitoring said selected plans; and
modifying said selected plans as required.

27. The method of claim 26, further comprising:
defining a plurality of tasks defining said selected plans.

28. The method of claim 27, further comprising:
decomposing said plurality of tasks into subtasks that become task commands for a subordinate network layer.

29. The method of claim 28, further comprising:
providing feedback regarding completion of said tasks and subtasks from subordinate network layers up to superior network layers.
